(19) United States
(12) Patent Application Publication
(10) Pub. No.: US 2008/0313061 A1
(43) Pub. Date: Dec. 18, 2008

(54) System and Method for Facilitating Transfer of Physical Money and/or Credit

(75) Inventor: Enriquez Eugenio Donato Renato Limlengco, Makati City (PH)

Correspondence Address: INTELLECTUAL PROPERTY LAW GROUP LLP, 12 SOUTH FIRST STREET, SUITE 1205, SAN JOSE, CA, 95113, US

(73) Assignee: PAYSETTER PTE LTD, Singapore (SG)

(21) Appl. No.: 11/571,515

(22) PCT Filed: Jun. 29, 2005
(86) PCT No.: PCT/SG2005/000215

§ 371 Date: Feb. 5, 2008

(30) Foreign Application Priority Data
Jun. 30, 2004 (SG) 200403809-7

(51) Int. Cl. G06Q 20/00; G06Q 10/00; G06Q 40/00

(52) U.S. Cl. 705/30; 705/44

(57) ABSTRACT

A system for transfer of physical money and/or credit comprises a transferring party with a first communication device; an intended recipient with a second communication device; a facilitator; and a third party, wherein the transferring party makes a payment to a third party and receives a unique payment code associated with the amount of the payment. The transferring party sends a first message to the facilitator using the first communications device. The first message includes the unique payment code and a unique identifier associated with the second communication device. The facilitator informs the intended recipient, via a second message including a trace number, sent to the second communication device of the intended transfer and the redemption process. The intended recipient attends the premises of a third party and obtains a unique identifier associated with a third communication device in their possession. The intended recipient sends a redemption message, including the trace number and the unique identifier to the facilitator.

### FIELD OF THE INVENTION

The present invention relates to a system and method for facilitating transfer of physical money and/or credit. The invention is particularly directed towards a system for facilitating transfer of physical money that utilises telecommunications systems to authenticate the recipient. The system and method may also be used for facilitating transfer of credit that can be used to purchase goods and/or services in addition to transferring physical money.

It should be noted that in the context of this invention the transfer of physical money refers to the ability of one party to pay physical money at one point and have physical money of a substantially equal amount provided to another party at a different location. It does not relate to transfer of the same physical money from one party to another.

### BACKGROUND ART

The following discussion of the background of the invention is intended to facilitate an understanding of the present invention. However, it should be appreciated that the discussion is not an acknowledgement or admission that any of the material referred to was published, known or part of the common general knowledge of the person skilled in the art in any jurisdiction as at the priority date of the application.

Transferring money from one party to another can be achieved by a variety of means. For example:
the transferring party may physically hand over the money to the recipient;
the transferring party may organise a wire transfer to the recipient; or
the transferring party may organise an electronic payment to be made to the recipient.

Each of these methods has drawbacks.

In the case of physical transfer of cash, both the transferring party and recipient need to physically meet to effect the transfer. This can often be impractical due to one party being too busy to meet, or simply because of the geographical distance between the transferring party and recipient.

In the case of wire transfer, the money transferred is locked into the infrastructure setup of the wire transfer provider. As such, it may not be possible to organise a wire transfer to a recipient who is not in close proximity to the wire transfer provider's infrastructure. Additionally, it may again be impractical for the recipient to attend the wire transfer provider's premises to obtain the physical money due to time constraints or other mobility issues.

Electronic payment also has problems. While the money is provided to the recipient regardless of their location, it presupposes that the recipient has an account that an electronic payment can be made to. This is not the case in some countries where subsistence living is the norm. Further, while the recipient is technically in receipt of the money, there can be difficulties in transforming the received money into physical form. Thus, in certain situations where physical money is required, and is the reason for the transfer, transfer by means of electronic payment may not be the required solution.

It is therefore an object of the present invention to provide a system that overcomes, or at least ameliorates, some or all of the abovementioned problems.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the present invention there is provided a system for facilitating transfer of physical money and/or credit from a transferring party to an intended recipient comprising:
a first telecommunications device possessed by the transferring party;
second telecommunications device possessed by the intended recipient;
a facilitator; and
at least one third party,
   where, the transferring party makes a payment to a third party of the at least one third party and receives a unique payment code associated with the amount of the payment in return. A first communication message is then sent to a destination address associated with the facilitator, preferably by the transferring party using the first telecommunications device. The first communication message includes the unique payment code and a unique identifier associated with the second communication device. The facilitator then informs the intended recipient, via a second communication message sent to the second communication device, of the intended transfer and the redemption process. This second communication message includes a trace number. The intended recipient then attends the premises of a third party, who may or may not be the same third party as received the payment from the transferring party, and obtains a unique identifier associated with a third telecommunication device in their possession. Once obtained, the intended recipient sends a redemption communication message to the facilitator. The redemption communication message includes the trace number specified in the communication message and the unique identifier associated with the third telecommunication device. If the transaction has not already been completely redeemed, the facilitator operates to send an authorisation communication message to the third telecommunication device, upon receipt of which the third party who possesses the third telecommunication device makes a payment to the intended recipient of an amount up to or substantially equal to the payment made by the transferring party. To facilitate communication, one or more of the components of the various communication messages may be omitted from the body of the communication message itself and included as DTMF suffixes to the intended destination address of each of the various communication messages. Similarly, multiple destination addresses may be used to distinguish first communication messages from redemption communication messages.

The first communication message may include a personalised message which the facilitator includes in the second communication message.

The facilitator may operate to identify a unique identifier for the first communication device from the information associated with the first communication message. In this manner, the facilitator can convey a confirmation message to the transferring party confirming receipt of the first communication message.

Additionally, the facilitator may operate to convey a corresponding or correlating authorisation message to the intended recipient. In such an arrangement, it is envisaged that the intended recipient will be required to display the corresponding or correlating authorisation message to the third party in order for payment to be made. In this manner, the third party has some level of confirmation that they are making payment to the appropriate person.

A database used to record comparisons between unique payment codes and payment values may also be used to record more general details about each transaction. Transactions may be marked as redeemed or deleted as desired by the facilitator.

The intended recipient may specify an amount for redemption in the redemption communication message. If the system is set up to handle partial redemptions, the facilitator may operate to authorise the partial redemption by means of authorisation message(s). At the same time the record in the database referencing the transaction would be updated to reflect the partial redemption. If as a result of the partial redemption, the value able to be redeemed is reduced to zero, the transaction is marked as redeemed or deleted as referred to above. Also, if no amount is specified, the facilitator will assume that the intended recipient wishes to redeem the full amount of the value able to be redeemed.

Authorisation message(s) may be correlated by means of a receipt number. The receipt number may be the same as the trace number. However, the receipt number may also be used by the third party for their own reconciliation purposes. The unique payment code may be imprinted on a transfer card. To prevent fraud, the unique payment code may be hidden by a scratch pane or other like concealment mechanism. Alternatively, the third party may employ an electronic device to automatically generate, or receive, a unique payment code that is then provided to the transferring party.

The unique payment code may also be associated with a monetary value representative of the value of at least one pre-paid service offered by the facilitator and at least one of the third parties.

The facilitator may operate to perform their own reconciliation. This reconciliation determines how much to pay, on a predetermined timeframe basis, to each third party. Payment may be by way of electronic transfer to an account specified by each third party. Alternatively, payment may be by way of credit for the at least one pre-paid service offered by the facilitator and the third party. Examples of such pre-paid services include pre-paid air time for mobile phone users, gift certificates and movie passes. The payment may include a commission amount. This arrangement may be unnecessary where the facilitator undertakes the service on behalf of a single client or a group of clients participating in a profit-sharing arrangement.

The communications devices may take a variety of forms. While the preferred arrangement is for the communication device to be a mobile phone, it is possible for the system to work, albeit on a limited basis, using computers and e-mail addresses or pagers. Thus, communication messages may be by way of SMS message, MMS message, e-mail message or other form of communication. It may also be unnecessary for the intended recipient to be in possession of the second communication device at the time of redemption—a communication device in the possession of a third party may be used as the initiator of the redemption communication message.

The destination address of the first communication message or redemption communication message may be associated with the payment represented by the unique payment code.

A validity check of the unique identifier of the second communication device specified in the first communication message may be undertaken. If the validity check fails, the facilitator may then send a failure communication message to the transferring party to inform them of this error. Similarly, a validity check of the unique identifier specified in the redemption communication message may be undertaken to ensure that the third party is authorised by the system to handle the redemption.

The third parties may be retail stores or individuals.

In accordance with a second aspect of the invention there is a facilitator for use in a system for facilitating the transfer of physical money and/or credit as described in the first aspect of the invention above.

In accordance with a third aspect of the invention there is a third party for use in a system for facilitating the transfer of physical money and/or credit as determined in the first aspect of the invention above. The third party may be the party who receives payment from the transferring party or the third party who makes payment to the intended recipient.

In accordance with a fourth aspect of the present invention there is a method for facilitating transfer of physical money and/or credit comprising:
receiving a first communication message at a destination address from a transferring party, the first communication message including a unique payment code associated with an amount paid to a third party by the transferring party and a unique identifier associated with a second communication device possessed by an intended recipient of the amount paid;
informing the intended recipient via a second communication message sent to the second communication device of the intended transfer and the redemption process, the second communication message including a trace number;
receiving a redemption communication message from the intended recipient at the destination address, the redemption communication message including a unique identifier associated with a third communication device in possession of a third party, who may or may not be the same third party as received the payment from the transferring party, and the trace number;
sending an authorisation communication message to the third communication device if the transaction associated with the trace number has not already been completely redeemed, on receipt of which the third party in possession of the communication device that receives the authorisation communication message operable to make a payment to the intended recipient of an amount up to or substantially equal to the payment made by the transferring party.

Alternatively, the method may include the step of parsing the destination address to determine the DTMF suffixes representing one or more of the components of the various communication messages that may be omitted from the body of the communication message

Preferably, the method includes the steps of identifying a personalised message included in the first communication message and including the personalised message in the second communication message.

Ideally, the method includes the steps of identifying a unique identifier for a first communication device associated with the transferring party from information associated with the first communication message and sending a confirmation message to the transferring party, via the first communication device, confirming receipt of the first communication message.

In a preferred arrangement, the method includes the step of conveying a corresponding or correlating authorisation message to the intended recipient. The intended recipient may be required to display the corresponding or correlating authorisation message to the third party in order for payment to be made.

The method may also includes the step of marking as redeemed or deleted transaction records stored in a database on successful processing of a redemption communication message.

Preferably, the method includes the steps of:
receiving an amount for redemption as part of the redemption communication message;
reducing the value available for redeemed as stored in the corresponding transaction record by the redemption amount specified in the redemption communication message.

Ideally, the method includes the step of associating the unique payment code with a monetary value representative of a value of at least one pre-paid service offered by the facilitator and at least one of the third parties, the monetary value also being able for redemption on successful processing of the redemption communication message.

The method may also include the step of performing a reconciliation so as to determine how much to pay, on a predetermined timeframe basis, to each third party. More preferably, the method includes the step of making payment to each third party by way of credit for the at least one pre-paid service offered by the facilitator and the third party.

Preferably, the method includes the steps of performing a validity check on the unique identifier of the second communication device as specified in the first communication message, and sending a failure communication message if the unique identifier of the second communication device cannot be validated. More preferably, the method includes the steps of performing a validity check on the unique identifier of the third communication device as specified in the redemption communication message, and sending a failure communication message if the unique identifier of the third communication device cannot be validated.

### BRIEF DESCRIPTION OF THE DRAWINGS

A preferred embodiment of the present invention will now be described with reference to the drawings, of which:

FIG. 1 is a schematic diagram of a first embodiment of a system for facilitating the transfer of physical money and/or credit.

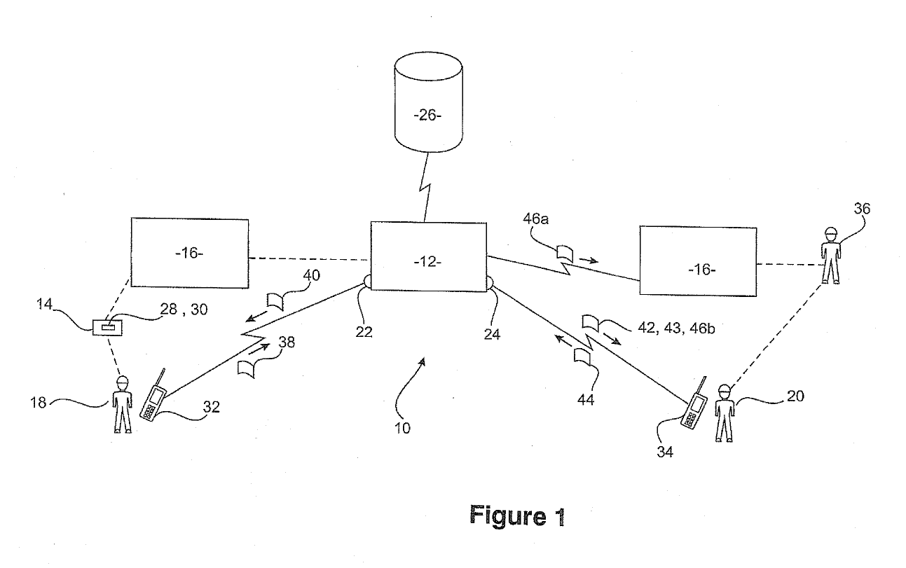

FIG. 2 is a schematic diagram of a second embodiment of a system for facilitating the transfer of physical money and/or credit.

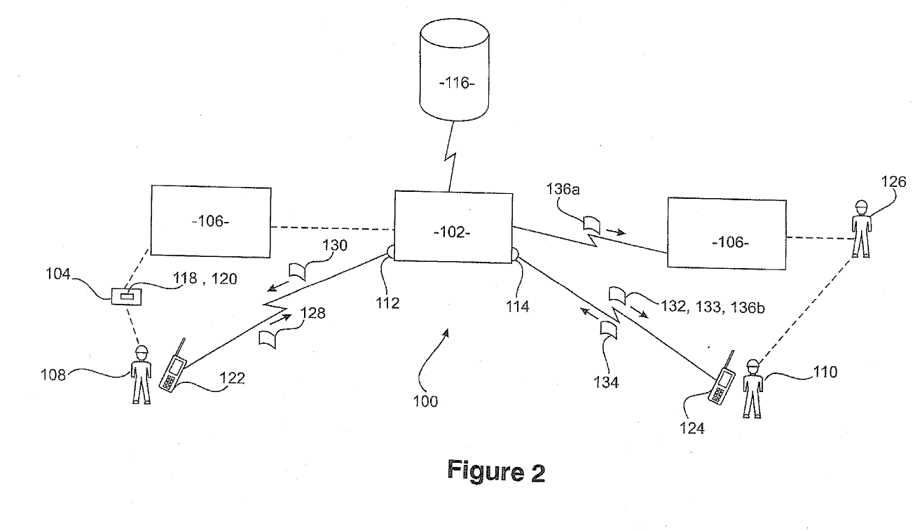

FIG. 3 is a schematic diagram of a third embodiment of a system for facilitating the transfer of physical money and/or credit.

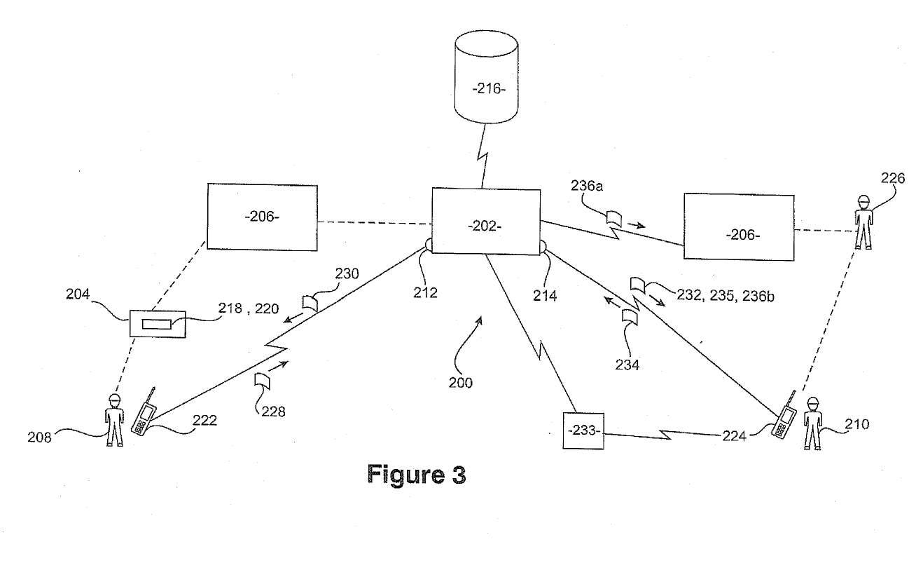

### BEST MODE(S) FOR CARRYING OUT THE INVENTION

In accordance with a first embodiment of the invention there is a system 10 for facilitating the transfer of physical money. The system comprises:
a facilitator 12;
at least one transfer card 14;
at least one retail store 16;
a transferring party 18; and
an intended recipient 20.

The facilitator 12 is in data communication with the transferring party 18, intended recipient 20 and at least one retail store 16 and vice-versa. The facilitator 12 is associated with a destination address 22 and a second destination address 24 to enable such data communication.

The facilitator 12 also operates a database 26 to record details of all redemption transactions.

Transfer cards 14 include a scratch pane 28 (described in more detail below). Printed on the face of each transfer card 14 is the value of money that can be transferred to the intended recipient 20.

Both the transferring party 18 and the intended recipient 20 possess mobile phones 32, 34 each having a unique mobile phone number.

Each retail store 16 may employ one or more attendants 36.

The system 10 will now be described in the context of its intended use.

The facilitator 12 mass produces transfer cards 14 and distributes them to the various retail stores 16. Each scratch pane 28 of the transfer card 14 covers a unique payment code. The unique payment code of each transfer card 14 is recorded by the facilitator 12 in the database 26, along with the face value 30 printed on that transfer card 14.

A transferring party 18 then enters into a retail store 16 and purchases a transfer card 14 having a face value 30 equal to the amount desired to be transferred. The transferring party 18 then scratches off the material covering the scratch pane 28 to reveal the unique payment code printed underneath.

The transferring party 18 then sends a communication message 38 to the destination address 22 referred to on the transfer card 14 using the transferring party's 18 mobile phone 32. The communication message 38 includes:
the unique payment code of the transfer card 14; and
the mobile phone number 34 of the intended recipient 20.

As mentioned above, the destination address 22 referred to on the transfer card 14 is associated with the facilitator 12. Accordingly, the facilitator 12 operates to process the communication message 38 on receipt thereof.

Processing of the communication message 38 commences by parsing the communication message 38 to determine the unique payment code and the intended recipient's 20 mobile phone number 34. The facilitator 12 then checks the unique payment code against the records in the database 26 until a record having a matching unique payment code is found. The facilitator 12 also identifies the mobile phone number 32 of the transferring party 18 as would be known to the person skilled in the art, such as caller ID.

The facilitator 12 also allocates a unique trace number to the transfer transaction. Details of the transaction are then stored in the database 26, indexed by the unique trace number.

The facilitator 12 then sends a reply communication message 40 to the identified mobile phone number 32 of the transferring party 18. The reply communication message 40 informs the transferring party 18 of the mobile phone number 34 of the intended recipient 20, the face value 30 amount of the transfer card 14 (representative of the amount to be transferred) and the unique trace number of the transfer transaction.

The facilitator 12 also sends a transfer communication message 42 to the mobile phone number 34 of the intended recipient 20. The transfer communication message 42 informs the intended recipient 20 of:
the amount of money available for their redemption;
the mobile phone number 32 of the transferring party 18;
the trace number of the transfer transaction; and
brief details of how the intended recipient 20 can redeem the money.

The intended recipient 20 is then able to attend a retail store 16 and seek to redeem the money. The retail store 16 that the intended recipient 20 attends need not be the same retail store 16, or a retail store 14 of the same group, as that that the transferring party 18 attended.

The process of redeeming the transferred money is initiated by the intended recipient 20 recording details of the retail store 16 from an attendant 36, which includes the retail store's 16 phone number. The intended recipient 20 then sends a redemption communication message 44 to a second destination address 24. The redemption communication message 44 includes:
the trace number of the transfer transaction;
the retail store's 16 phone number; and
the amount of redemption.

The second destination address 24 is also associated with the facilitator 12. The facilitator 12 operates to parse the redemption communication message 44 on receipt to determine each of the above-mentioned elements.

The facilitator 12 then checks the elements of the redemption communication message 44 against previous transaction details stored in the database 26. On finding a record having a trace number matching the trace number in the redemption communication message 44, the facilitator checks the remaining information in the redemption communication message 44 against the corresponding information in the matching record. The facilitator 12 also checks to ensure that the matching record has not already been recorded as redeemed. If the matching record is marked as redeemed, the facilitator 12 operates to send a denial communication message 43 to the intended recipient 20.

If the information in the redemption communication message 44 matches in all particulars with the matching record stored in the database 26 and has not already been redeemed, the facilitator 12 undertakes to mark the matching record as redeemed and record the identity of the redeeming retail store 16. In this manner, redemption cannot occur more than once.

Additionally, if the matching record has not already been recorded as redeemed, the facilitator 12 sends an authorisation communication message 46a to the retail store's phone number as well as sending a corresponding authorisation communication message 46b to the intended recipient 20. It is only when the attendant 36 receives the authorisation communication message 46a, and the intended recipient 20 shows the attendant 36 their corresponding authorisation communication message 46b, that the attendant 36 makes a monetary payment to the intended recipient 20 equal to the amount specified in the authorisation communication message 46a. In this manner, the attendant 36 need not deal with customer service issues resulting from refusal of redemption by the facilitator 12. The authorisation communication message 46a also includes a receipt number to be used by the attendant 36 during end-of-day reconciliation to account for the redemption payment.

At the end of the day, the facilitator 12 performs a reconciliation of redeemed transactions grouped by retail store 16. A total is then calculated for each retail store 16 representing the amount paid out by the retail store 16 as redemption payments during the day. The facilitator 12 then operates to make a payment to the retail store 16 equal to the calculated total.

In accordance with a second embodiment of the invention there is a system 100 for facilitating the transfer of physical money. The system comprises:
a facilitator 102;
at least one transfer card 104;
at least one retail store 106;
a transferring party 108; and
an intended recipient 110.

The facilitator 102 is in data communication with the transferring party 108, intended recipient 110 and at least one retail store 106 and vice-versa. The facilitator 102 is associated with a destination address 112 and a second destination address 114 to enable such data communication.

The facilitator 102 also operates a database 116 to record details of all redemption transactions.

Each retail store 106 may employ one or more attendants 126. Each retail store 106 also offers at least one pre-paid service, such as pre-paid mobile phone services, that the facilitator 102 also provides or that are provided by an entity associated with the facilitator 102.

Transfer cards 104 include a scratch pane 118 (described in more detail below). Printed on the face of each transfer card 104 is:
a card number;
the value of money that can be transferred to the intended recipient 110; and
the monetary value of the at least one pre-paid service that can be credited to the intended recipient 110.

The proportion of the total value of the transfer card 104 allocated to the monetary value may vary from transfer card 104 to transfer card 104.

Both the transferring party 108 and the intended recipient 110 possess mobile phones 122, 124 each having a unique mobile phone number.

The system 100 will now be described in the context of its intended use.

The facilitator 102 mass produces transfer cards 104 and distributes them to the various retail stores 106. Each scratch pane 118 of the transfer card 104 covers a unique payment code. The unique payment code of each transfer card 104 is recorded by the facilitator 102 in the database 116, along with the face values 120 printed on that transfer card 104 and the card number.

A transferring party 108 then enters into a retail store 106 and purchases a transfer card 104 having a face value 120 equal to the amount desired to be transferred. The transferring party 108 then scratches off the material covering the scratch pane 118 to reveal the unique payment code printed underneath.

The transferring party 108 sends a communication message 128 to the destination address 112 referred to on the transfer card 104 using the transferring party's 108 mobile phone 112. The communication message 128 includes:
the card number;
the unique payment code of the transfer card 104;
the mobile phone number of the intended recipient 110; and
a text message for the intended recipient 110;

As mentioned above, the destination address 112 referred to on the transfer card 104 is associated with the facilitator 102. Accordingly, the facilitator 102 operates to process the communication message 128 on receipt thereof.

Processing of the communication message 128 commences by parsing the communication message 128 to determine the card number, unique payment code and the intended recipient's 110 mobile phone number 124. The facilitator 102 then checks the card number against the records in the database 116 until a record having a matching card number is found. The facilitator 102 also identifies the mobile phone number 122 of the transferring party 108 using techniques as would be known to the person skilled in the art, such as caller ID.

The facilitator 102 also allocates a unique trace number to the transfer transaction. Details of the transaction are then stored in the database 116, indexed by the unique trace number.

The facilitator 102 then sends a reply communication message 130 to the transferring party 108. The reply communication message 130 informs the transferring party 108 of the mobile phone number 124 of the intended recipient 110, the face value amounts 120 of the transfer card 104 (representative of the amount to be transferred) and the unique trace number of the transfer transaction. The facilitator 102 also sends a transfer communication message 132 to the mobile phone number 124 of the intended recipient 110. The transfer communication message 132 informs the intended recipient 110 of:
the amount of money available for their redemption;
the monetary value that has been credited to them in relation to the pre-paid service;
the mobile phone number 122 of the transferring party 108;
the trace number of the transfer transaction;
the text message included in the communication message 128 and
brief details of how the intended recipient 110 can redeem the money.

The intended recipient 110 is then able to attend a retail store 104 and seek to redeem the money. The retail store 104 that the intended recipient 110 attends need not be the same retail store 104, or a retail store 104 of the same group, as that that the transferring party 108 attended.

The process of redeeming the transferred money is initiated by the intended recipient 110 recording details of the retail store 104 from an attendant 126, which includes the retail store's 104 phone number. The intended recipient 110 then sends a redemption communication message 134 to a second destination address 114. The redemption communication message 114 includes:
the trace number of the transfer transaction;
the retail store's 104 phone number; and
the amount of redemption.

The second destination address 114 is also associated with the facilitator 102. The facilitator 102 operates to parse the redemption communication message 134 on receipt to determine each of the above-mentioned elements.

The facilitator 102 then checks the elements of the redemption communication message 134 against previous transaction details stored in the database 116. On finding a record having a trace number matching the trace number in the redemption communication message 134, the facilitator checks the remaining information in the redemption communication message 134 against the corresponding information in the matching record. The facilitator 102 also checks to ensure that the matching record has not already been recorded as redeemed. If the matching record is marked as redeemed, the facilitator 102 operates to send a denial communication message 133 to the intended recipient 110.

If the information in the redemption communication message 134 matches in all particulars with the matching record stored in the database 116 and has not already been redeemed, the facilitator 102 undertakes to mark the matching record as redeemed and record the identity of the redeeming retail store 104. In this manner, redemption cannot occur more than once.

Additionally, if the matching record has not already been recorded as redeemed, the facilitator 102 sends an authorisation communication message 136a to the retail store's 104 phone number as well as sending a corresponding authorisation communication message 136b to the intended recipient 110. It is only when the attendant 126 receives the authorisation communication message 136a, and the intended recipient 110 shows the attendant 126 their corresponding authorisation communication message 136b, that the attendant 126 makes a monetary payment to the intended recipient 110 equal to the amount specified in the authorisation communication message 136a. In this manner, the attendant 126 need not deal with customer service issues resulting from refusal of redemption by the facilitator 102.

The authorisation communication message 136a also includes a receipt number to be used by the attendant 126 during end-of-day reconciliation to account for the redemption payment.

At the end of the day, the facilitator 102 performs a reconciliation of redeemed transactions grouped by retail store 106. A total is then calculated for each retail store 106 representing the amount paid out by the retail store 106 as monetary redemption payments during the day. The facilitator 102 then operates to transfer credit to the retail store 106 equal to the calculated monetary amount plus a predetermined commission percentage (which may take the form of pre-paid service cards). The transfer credit relates to the pre-paid service, such that the retail store 106 can then sell the transferred credit to its own customers.

In accordance with a third embodiment of the invention there is a system 200 for facilitating the transfer of physical money. The system comprises:
a facilitator 202;
at least one transfer card 204;
at least one retail store 206;
a transferring party 208; and
an intended recipient 210.

The facilitator 202 is in data communication with the transferring party 208, intended recipient 210 and at least one retail store 206 and vice-versa. The facilitator 202 is associated with a destination address 202 and a second destination address 214 to enable such data communication.

The facilitator 202 also operates a database 216 to record details of all redemption transactions.

Transfer cards 204 include a scratch pane 218 (described in more detail below). Printed on the face of each transfer card 204 is the value of money that can be transferred to the intended recipient 210.

Both the transferring party 208 and the intended recipient 210 possess mobile phones 222, 224 each having a unique mobile phone number.

Each retail store 206 may employ one or more attendants 226.

The system 200 will now be described in the context of its intended use.

The facilitator 202 mass produces transfer cards 204 and distributes them to the various retail stores 206. Each scratch pane 218 of the transfer card 204 covers a unique payment code. The unique payment code of each transfer card 204 is recorded by the facilitator 202 in the database 216, along with the face value 220 printed on that transfer card 204.

A transferring party 208 then enters into a retail store 206 and purchases a transfer card 204 having a face value 220 equal to the amount desired to be transferred. The transferring party 208 then scratches off the material covering the scratch pane 218 to reveal the unique payment code printed underneath.

The transferring party 208 then sends a communication message 228 to the destination address 212 referred to on the transfer card 204 using the transferring party's 208 mobile phone 222. The communication message 228 includes:
the unique payment code of the transfer card 204; and
the mobile phone number 224 of the intended recipient 210.

As mentioned above, the destination address 212 referred to on the transfer card 204 is associated with the facilitator 202. Accordingly, the facilitator 202 operates to process the communication message 228 on receipt thereof.

Processing of the communication message 228 commences by parsing the communication message 228 to determine the unique payment code and the intended recipient's 210 mobile phone number 224. The facilitator 202 then checks the unique payment code against the records in the database 216 until a record having a matching unique payment code is found. The facilitator 202 also identifies the mobile phone number 222 of the transferring party 208 as would be known to the person skilled in the art, such as caller ID.

The facilitator 202 also allocates a unique trace number to the transfer transaction. Details of the transaction are then stored in the database 216, indexed by the unique trace number.

The facilitator 202 then sends a reply communication message 230 to the identified mobile phone number 222 of the transferring party 18. The reply communication message 230 informs the transferring party 208 of the mobile phone number 224 of the intended recipient 210, the face value 220 amount of the transfer card 204 (representative of the amount to be transferred) and the unique trace number of the transfer transaction.

At the same time facilitator 202 performs a check to determine whether the intended recipient 210 has linked their mobile phone number 224 with an account 233. If so, the facilitator 202 operates to make an electronic payment to the account 233 equal to the amount of money to be transferred to the intended recipient 210. The process for linking an account 233 with a mobile phone number 224 is described fully in the applicant's prior patent application PCT/SG2002/00172, incorporated herein by cross-reference.

However, if the intended recipient 210 has not linked their mobile phone number 224 with an account 233, the facilitator 202 operates to establish an account 233 for them. The process for establishing an account on behalf of an intended recipient 210 is described fully in the applicant's prior patent applications PCT/SG2004/000099 and PCT/SG2005/000036, also incorporated herein by cross-reference. The facilitator 202 then operates to make an electronic payment to the account 233 equal to the amount of money to be transferred to the intended recipient 210.

The facilitator 202 also sends a transfer communication message 232 to the mobile phone number 224 of the intended recipient 210. The transfer communication message 232 informs the intended recipient 210 of:
the amount of money that has been credited to the account 233 in their name;
the mobile phone number 222 of the transferring party 208;
the trace number of the transfer transaction; and
brief details of how the intended recipient 210 can redeem the money if the intended recipient 210 has not already linked an account 233 with their mobile phone number 224. If the intended recipient 210 has already linked an account 233 with their mobile phone number 224, it is presumed that the intended recipient already knows how to access the money credited to said account 233.

In the situation where the intended recipient 210 has not already linked an account 233 with their mobile phone number 224, or the intended recipient 210 wishes to use the retail store 206 as a means of obtaining the money, the process for redeeming the money credited is described below.

The intended recipient 210 attends a retail store 206. The retail store 206 that the intended recipient 210 attends need not be the same retail store 206, or a retail store 206 of the same group, as that that the transferring party 208 attended.

The process of redeeming the money transferred to account 233 is initiated by the intended recipient 210 recording details of the retail store 206 from an attendant 226, which includes the retail store's 206 phone number. The intended recipient 210 then sends a redemption communication message 234 to a second destination address 214. The redemption communication message 234 includes:
the trace number of the transfer transaction;
the retail store's 206 phone number; and
the amount of redemption.

The second destination address 214 is also associated with the facilitator 202. The facilitator 202 operates to parse the redemption communication message 234 on receipt to determine each of the above-mentioned elements.

The facilitator 202 then checks the elements of the redemption communication message 234 against previous transaction details stored in the database 216. On finding a record having a trace number matching the trace number in the redemption communication message 234, the facilitator checks the remaining information in the redemption communication message 234 against the corresponding information in the matching record. The facilitator 202 also checks to ensure that the matching record has not already been recorded as redeemed. If the matching record is marked as redeemed, the facilitator 202 operates to send a denial communication message 235 to the intended recipient 210.

If the information in the redemption communication message 234 matches in all particulars with the matching record stored in the database 216 and has not already been redeemed, the facilitator 202 undertakes to mark the matching record as redeemed and record the identity of the redeeming retail store 206. In this manner, redemption cannot occur more than once.

Additionally, if the matching record has not already been recorded as redeemed, the facilitator 202 sends an authorisation communication message 236a to the retail store's 206 phone number as well as sending a corresponding authorisation communication message 236b to the intended recipient 210. It is only when the attendant 226 receives the authorisation communication message 236a, and the intended recipient 210 shows the attendant 226 their corresponding authorisation communication message 236b, that the attendant 226 makes a monetary payment to the intended recipient 210 equal to the amount specified in the authorisation communication message 236a. In this manner, the attendant 226 need not deal with customer service issues resulting from refusal of redemption by the facilitator 202.

The authorisation communication message 236a also includes a receipt number to be used by the attendant 226 during end-of-day reconciliation to account for the redemption payment.

At the end of the day, the facilitator 202 performs a reconciliation of redeemed transactions grouped by retail store 206. A total is then calculated for each retail store 16 representing the amount paid out by the retail store 206 as redemption payments during the day. The facilitator 202 then operates to make a payment to the retail store 206 equal to the calculated total.

It should be appreciated by the person skilled in the art that the invention is not limited to the examples described. In particular, the following additions and/or modifications can be made without departing from the scope of the invention:
The facilitator 12 may operate to perform a validity check on the intended recipient's 20 mobile phone number 34, as specified in communication message 38. If the intended recipient's 20 mobile phone number 34 specified in the communication message 38 fails the validity check, facilitator 12 sends an invalidity communication message to transferring party 18 informing them that the transfer has not been able to be processed as the specified intended recipient's 20 mobile phone number 34 is invalid.
The intended recipient's 20 mobile phone number 34, and/or the retail store's 16 phone number may be omitted from communication message 38 and/or redemption communication message 44 as appropriate. In its place, the intended recipient's 20 mobile phone number 34 and/or the retail store's 16 phone number may be included as a suffix of the destination address communication message 38 and/or redemption communication message 44, as appropriate, is sent to. In this manner, communication message 38 and redemption message 44 need only specify the trace number of the transaction.
The trace number of a transaction may be included as a suffix of the destination address communication message 38 and/or redemption communication message 44 is sent to. In this manner, communication message 38 and redemption message 44 need only specify the intended recipient's 20 mobile phone number 34 and/or the retail store's 16 phone number, as appropriate.
The destination address communication message 38 and/or redemption communication message 44 is sent to may be associated with the amount to be transferred to the intended recipient 20.
Authorisation communication message 46b may be omitted.
Transfer cards 14 may be omitted. In its place, the retail store 16 may have apparatus that communicates with the facilitator 12 to create a transfer receipt on demand. The transfer receipt includes the same information as the transfer cards 14 described above—thus allowing processing to continue thereafter as already described. Alternatively, the apparatus may operate to generate communication message 38.
The various communication messages may take the form of SMS messages, MMS messages, e-mail messages amongst others. The information of each communication message may also be imparted by way of voice communication.
Special characters or other such delimiters as would be known to the person skilled in the art can be used to separate the various pieces of information and thereby assist in the parsing process.
Reply communication message 40 may be omitted.
Mobile phones 32, 34 may be replaced with other mobile communication devices, such as a pager. Processing would then be modified in a manner as would be apparent to the person skilled in the art.
The authorisation communication messages 46 may omit the receipt number.
Retail store 16 may operate to forward all money received from purchase of transfer cards 14 to the facilitator 12. Alternatively, the retail store 16 may operate to offset the money received from the purchase of transfer cards 14 from the amount of money paid out as redemption payments—the balance being paid to the facilitator 12 or retail store 16 as appropriate.
The system 10 may be operated in respect of retail stores 16 that form part of the same legal entity. In such an arrangement, all money received and paid out may be handled internally by the accounting systems of the legal entity. The legal entity may then pay the facilitator either a commission or fixed fee payment for coordinating the authorisation procedure referred to above.
The pre-paid service may take the form of credit that can be used to purchase goods and/or services (ie. a gift voucher).
As an alternative to marking transaction records in the database as redeemed, transaction records may be deleted upon redemption.
The transferring party 108 may operate either a pre- or post-paid mobile phone account. Payment for the transfer payment may be deducted or added, as appropriate, to the mobile phone account.
Where the pre-paid service is mobile phone credit, if the intended recipient 110 operates a pre-paid mobile phone account, the intended recipient's 110 credit balance will be increased by the amount specified. Alternatively, if the intended recipient 110 operates a post-paid mobile phone account, the facilitator 12 will operate to make a payment of the intended recipient's 110 mobile phone account equal to the amount specified Further, the facilitator 102 may either be a part of, or associated with, the telecommunications carrier that provides the mobile phone service to the intended recipient 110.
Rather than crediting the monetary value of the at least one pre-paid service that can be credited immediately to the intended recipient 110 on receipt of communication message 128, the system 100 may operate to credit the intended recipient with the monetary value of the at least one pre-paid service only when a redemption communication message 134 has been successfully processed. Similarly, in respect of the third embodiment, where the intended recipient 210 has not already linked an account 233 to their mobile phone number 224, the facilitator 202 may operate to delay payment to, or establishment of, the account 233 until a redemption communication message 134 has been successfully processed.
A transfer may consist solely of monetary value of the at least one pre-paid service that can be credited.
The system 10 may be amended to allow for partial redemptions of money and or the monetary value of the at least one pre-paid service that can be credited. In this manner, rather than marking a record in database 26 as redeemed on a redemption communication message 44 being successfully processed, the record may be amended by reducing the value able to be redeemed by an amount specified in the redemption communication message 44. If the amount specified in the redemption communication message 44 reduces the value able to be redeemed to zero, then the record may be marked redeemed or deleted as appropriate. The facilitator 12 may also operate to check whether the amount specified in the redemption communication message 44 exceeds the value able to be redeemed and, if so, operate to inform the intended recipient 20 of this fact or, alternatively, operate to authorise payment of only the value able to be redeemed by the attendant 36.
In the arrangement specified in the last paragraph, if no amount is specified, it is assumed that the intended recipient wishes to redeem the full amount of the value able to be redeemed.
On receipt of a redemption communication message 44, the facilitator 12 may perform a validity check on the retail store's 16 phone number as recorded in the redemption communication message 44. In this manner, if the retail store's 16 phone number is not considered valid, the redemption communication message 44 can be rejected without redemption taking place. This allows the facilitator 12 an element of control over participants in the system 10. This also allows the redemption communication message 44 to replace the retail store's 16 phone number with some other unique identifier.

It should be further appreciated by the person skilled in the art that features and modifications discussed in the examples above, not being alternatives or substitutes, can be combined to form yet other embodiments that fall within the scope of the invention described.

The claims Defining the Invention are as Follows

1. A system for transferring physical money and/or credit between telecommunications subscribers comprising:
a first telecommunications device associated with a first telecommunications subscriber account;
a second telecommunication device associated with a second telecommunications subscriber account;
a facilitator; and
at least one third party;
where, a transferring party in possession of said first telecommunications device makes a payment to one third party of said at least one third party, and said one third party allocates to the transferring party a unique payment code associated with the payment; and,
a first communication message including said unique payment code and a second telecommunication device unique identifier associated with said second telecommunication device is sent to a destination address associated with said facilitator, the second telecommunication device being possessed by an intended recipient of said payment;
where said facilitator sends a second communication message to said second telecommunication device to inform the intended recipient of the intended transfer and optionally the redemption process, said second communication message including a trace identifier;
where the intended recipient then attends the premises of or contacts said one third party or another third party of said at least one third party, and obtains a third communication device unique identifier associated with a third communication device possessed by the third party, and a redemption communication message is sent to said facilitator, said redemption communication message including said trace identifier and said third communication device unique identifier;
where if the payment has not already been completely redeemed, said facilitator operates to send an authorisation communication message to said third communication device, upon receipt of which the third party in possession of the third communication device makes part or all of said payment to the intended recipient, less any commission taken by a said at least one third party and/or said facilitator.

2. A system as claimed in claim 1 wherein to facilitate communication, components of the various communication messages selected from one or more of said payment amount, said unique payment code, said second telecommunication device unique identifier, said trace number, said third telecommunication device unique identifier, are omitted from the body of the respective communication message and included as DTMF suffixes to the intended addressees.

3. A system as claimed in claim 1 or 2 wherein multiple said destination addresses are used to distinguish said first communication messages from said redemption communication messages.

4. A system as claimed in any one of the preceding claims wherein the transferring party sends said first communication message to said destination address associated with said facilitator using said first telecommunications device.

5. A system as claimed in any one of the preceding claims wherein said first communication message includes a personalised message which the facilitator includes in the second communication message.

6. A system as claimed in any one of the preceding claims wherein said facilitator operates to identify a first communication device unique identifier from information associated with the first communication message, and subsequently operates to convey a confirmation message to the transferring party confirming receipt of the first communication message.

7. A system as claimed in any one of the preceding claims wherein simultaneously with sending said authorisation communication message, said facilitator sends a corresponding or correlating authorisation message to said second telecommunications device, for correlation with said authorisation communication message.

8. A system as claimed in any one of the preceding claims wherein said facilitator includes a database used to record data from transactions including payment amounts, unique payment codes and optionally more general details about each transaction, including said trace number and telecommunications device identifiers associated with each said transaction.

9. A system as claimed in claim 8 wherein transactions may be marked as redeemed or deleted in said database.

10. A system as claimed in any one of the preceding claims wherein said redemption communication message includes data pertaining to an amount for partial redemption by the intended recipient, and said authorisation communication message includes authorisation of the amount constituting the partial redemption.

11. A system as claimed in claim 10 as dependent on claim 8 or 9 wherein said facilitator records the partial redemption in the database referencing the transaction.

12. A system as claimed in claim 7 wherein said authorisation communication message and said authorisation message are correlated by means of a common receipt number.

13. A system as claimed in claim 12 wherein said trace number is used as the common receipt number.

14. A system as claimed in any one of the preceding claims wherein said unique payment code is imprinted on a transfer card provided to said transferring party by said one third party.

15. A system as claimed in claim 14 wherein said unique payment code is hidden on said transfer card by a scratch pane or other like concealment mechanism.

16. A system as claimed in claim 14 or 15 wherein said transfer card represents a fixed value payment referenced to said unique payment code, and said destination address to which the first communication message or redemption communication message is sent determines the payment represented by the unique payment code.

17. A system as claimed in any one of the preceding claims wherein said facilitator performs a validity check of the second telecommunication device unique identifier specified in the first communication message, and said facilitator sends a failure communication message to the first telecommunication device if the validity check fails.

18. A system as claimed in any one of the preceding claims wherein said facilitator conducts a validity check of the third unique identifier specified in the redemption communication message to ensure that the third party is authorised by the system to handle the redemption.

19. A system as claimed in any one of the preceding claims wherein said communications devices comprise mobile phones and/or compatible devices.

20. A facilitator for use in a system for facilitating the transfer of physical money and/or credit as claimed in any one of claims 1 to 19.

21. A third party telecommunications device for use in a system for facilitating the transfer of physical money and/or credit as claimed in any one of claims 1 to 19, for use by a third party receiving payment from the transferring party or making payment to the intended recipient.

22. A method for facilitating transfer of physical money and/or credit from a transferring party to an intended recipient comprising:
receiving a first communication message at a destination address (from a transferring party), the first telecommunication message including a unique payment code associated with a payment (associated with an amount paid) to a third party made by the transferring party and including a second telecommunication device unique identifier associated with a second telecommunication device possessed by an intended recipient of the payment;
informing the intended recipient via a second communication message sent to the second telecommunication device of the intended transfer and optionally the redemption process, the second communication message including a trace number;
receiving a redemption communication message from the intended recipient at the destination address, the redemption communication message including a unique identifier associated with a third telecommunication device in possession of said third party or another third party, and including the trace number;
sending an authorisation communication message to the third telecommunication device if the transaction associated with the trace number has not already been completely redeemed, on receipt of which the third party in possession of the third telecommunication device that receives the authorisation communication message operable to make a payment to the intended recipient of an amount up to or substantially equal to the payment made by the transferring party.

23. A method as claimed in claim 22 including the step of parsing the destination address to determine the DTMF suffixes representing one or more said payment amount, said unique payment code, said second telecommunication device unique identifier, said trace number, and said third telecommunication device unique identifier comprising components of the various respective communication messages that may be omitted from the body of the communication message

24. A method as claimed in claim 22 or 23 including the steps of identifying a personalised message included in the first communication message and including the personalised message in the second communication message.

25. A method as claimed in any one of claims 22 to 24 including the steps of identifying a first telecommunication device unique identifier for a first telecommunication device associated with the transferring party from information associated with the first communication message and sending a confirmation message to the transferring party, via the first telecommunication device, confirming receipt of the first communication message.

26. A method as claimed in any one of claims 22 to 25 including the step of conveying a corresponding or correlating authorisation message to the intended recipient.

27. A method as claimed in any one of claims 22 to 26 including the step of marking as redeemed or deleted transaction records stored in a database on successful processing of a redemption communication message.

28. A method as claimed in any one of claims 22 to 27 including the steps of:
receiving an amount for redemption as part of the redemption communication message;
reducing the value available for redeemed as stored in the corresponding transaction record by the redemption amount specified in the redemption communication message.

29. A method as claimed in any one of claims 22 to 28 including the step of associating the unique payment code with a monetary value representative of a value of at least one pre-paid service offered by the facilitator and at least one of the third parties, the monetary value also being able for redemption on successful processing of the redemption communication message.

30. A method as claimed in any one of claims 22 to 29 including the step of performing a reconciliation so as to determine how much to pay, on a predetermined timeframe basis, to each third party.

31. A method as claimed in claim 30 including the step of making payment to each third party by way of credit for the at least one pre-paid service offered by the facilitator and the third party.

32. A method as claimed in any one of claims 22 to 31 including the steps of performing a validity check on the unique identifier of the second communication device as specified in the first communication message, and sending a failure communication message if the unique identifier of the second communication device cannot be validated.

33. A method as claimed in claim 32 including the steps of performing a validity check on the unique identifier of the third communication device as specified in the redemption communication message, and sending a failure communication message if the unique identifier of the third communication device cannot be validated.

34. A facilitator for use in a method for facilitating the transfer of physical money and/or credit as claimed in any one of claims 22 to 33, said facilitator having a plurality of said destination addresses.

35. A third party telecommunications device for use in a method for facilitating the transfer of physical money and/or credit as claimed in any one of claims 22 to 33, for use by a third party receiving payment from the transferring party or making payment to the intended recipient.

36. A system for transferring physical money and/or credit between telecommunications subscribers substantially as herein described with reference to the drawings.

37. A method for transferring physical money and/or credit between telecommunications subscribers substantially as herein described with reference to the drawings.
